(19) United States
(12) Patent Application Publication
(10) Pub. No.: US 2004/0162133 A1
(43) Pub. Date: Aug. 19, 2004

(54) Novel display and novel video payline format

(76) Inventor: Kathleen Nylund Jackson, Scituate, MA (US)

Correspondence Address: Mark A. Litman & Associates, P.A., York Business Center, Suite 205, 3209 West 76th St., Edina, MN, 55435, US

(21) Appl. No.: 10/776,392

(22) Filed: Feb. 11, 2004

Related U.S. Application Data
(60) Provisional application No. 60/446,805, filed on Feb. 11, 2003.

(51) Int. Cl. A63F 13/00

(52) U.S. Cl. 463/20

(57) ABSTRACT

Paylines are displayed on a video gaming apparatus having a display surface by providing images of symbols in a pattern. The pattern may be selected from the group consisting of geometric shapes with an approximate central area or central spot from which sets of frames may radiate, such as octagonal patterns, hexagonal patterns, circle patterns or ellipse patterns. The patterns may be divided into radial or focal distributions of symbols. Active paylines may be predetermined by selection by a player, the paylines determining combinations of symbols that can identify an award.

### BACKGROUND OF THE INVENTION

1. Field of the Invention

The present invention relates to novel video wagering payline formats and to novel games that are played on those formats in primary games or in bonus events. This invention relates generally to gaming methods and apparatus of the slot machine type, and more particularly, to an improved single line and multiple payline gaming methods and apparatus wherein a video screen is able to display images of paylines in a new format that provides different payline and different game play capability to video gaming equipment. Image elements are arranged in a non-orthogonal and/or non-rectangular array and are combined with a plurality of individually selectable paylines intersecting various combination of the elements so as to give a game player various degrees of latitude in choosing potential outcomes available as a result of each gaming proposition. Means may also be provided for allowing selection of special payout opportunities based upon certain positional relationships between various individual or combinations of the image display format elements and their displayed symbols.

2. Background of the Art

Gaming or poker machines have been well known throughout the world for many years and have more gained considerable popularity throughout the Americas, Australia, Europe and Asia with quite substantial amounts of money wagered on these machines. There has been a tremendous change in gaming machines from the original versions of three-reel slot machines, especially since the advent of video gaming machines. Where reel-type slot machines have been limited by the number of reels and the physical limitations of a limited number of physical reels, video gaming has opened up many different variations of games, different paylines and different modes of play of old games. The possibilities for the variations in play have only begun to be tapped

With the growth that has occurred in the gaming machine market, there is intense competition between manufacturers to supply the various existing and new venues. When selecting a supplier of gaming machines, the operator of a venue will often pay close attention to the popularity of various games with their patrons. Therefore, gaming machine manufacturers are keen to devise games which are popular with players, as a mechanism for improving sales.

Many various strategies have been tried in the past to make games more enticing to players, and these strategies are often aimed at either increasing the maximum prize payable on a machine or creating at least the perception of more winning opportunities. The present invention falls into the latter category. For quite a few years, it has been possible to bet on more than one pay line of a slot machine simultaneously. However this feature has been restricted by the number of pay lines that could be achieved on the display format commonly used in slot machines.

In typical multiple payline gaming devices such as the slot machines found in many casinos throughout the world, a play field, face plate, video screen or other display means including a plurality of three, four or five reels, or other rotating objects or images thereto is often provided for either real or virtual spin operation. Each such object contains at least one symbol which, upon stoppage of the object's rotation, may align with one or more horizontally or diagonally extending paylines. The symbols aligned along a particular payline, when compared to a pay table, then determine the result of a gambling proposition. For example, if the gaming device is a three reel apparatus wherein, upon stopping of its rotation, each reel reveals three play symbols at a time, the device may contain up to three horizontal paylines and two diagonal paylines where each payline encompasses or extends across three play symbols at a time; i.e., one symbol or space therefor on each reel. Such an array is illustrated in FIG. 1 of the drawing and includes three reels 10-14 of a type usually positioned behind a real or virtual face plate 16 having windows or sets of windows 18-22 for revealing one or more reel carried symbols on each reel. The reels are independently driven and stopped at random positions by a reel drive system 23. The face plate 16 is also inscribed with 3 horizontal paylines 24-28 and 2 diagonal paylines 30 and 32. Note that each payline crosses a window or symbol location (or space therefor) on each reel. Although arguably such apparatus could also include additional diagonal paylines, crossing only two of the reels, no such payline configuration is known to exist. Note that in the illustrated arrangement, it would not be feasible to have vertical paylines, even though three play symbol locations would lie beneath the intersected windows, because the relationship between the three adjacent symbols on each reel is fixed and clearly not a random organization of elements.

Games of the illustrated type do not provide the player with play choices other than that directly associated with the number of coins or credits wagered. Since many players would enjoy the opportunity to make multiple wagers per play proposition, it will be appreciated that the prior art arrangement of reels, play symbols and paylines is rather limiting. There is therefore a need to provide a gaming element arrangement in which substantially more choice is given to the player in terms of selection of paylines and play volatility. This would be advantageous to the player in that his perceived chances of winning would be enhanced. At the same time, such an arrangement would be beneficial to the game proprietor in that it would tend to increase the number of wagers made by a player per play proposition.

U.S. Pat. No. 5,580,053 offered additional non-linear paylines, which in the case of that invention meant additional paylines across three rows and five columns that did not proceed in straight lines. Whereas in a traditional 3×5 set of frames there were only five possible paylines, the addition of non-linear paylines offered numerous additional paylines, and thus the opportunity for more wager to be placed on a single spin of the reels.

U.S. Pat. No. 6,241,607 also offers a series of non-linear paylines, orienting frames in triangular or star-like sets, with distinct paylines being offered within lines passing through sets of frames.

### SUMMARY OF THE INVENTION

A novel slot machine payline system is based on the ability to independently wager on one or more sections of a particular shape or distribution of frames. With an initial specific shape or distribution of frames (for instance a circle), the shape is conceptually or visually divided into any number of at least two equal or unequal sections. One or more central or single center sections may be added to the distribution of sections. An equal (preferable) or unequal number of various symbols is distributed into each section when the player makes a wager and the game is initiated. If the symbols in a particular wagered section are deemed a win according to a predetermined pay table, the player collects on his wager. The system is useful as either a primary or bonus round game.

### BRIEF DESCRIPTION OF THE FIGURES

FIG. 1 shows a typical video gaming display of reel positions to determine payout lines.

FIG. 2 shows a video monitor and panel with player control buttons and eight wagering arcs of 45° segments of a circle.

FIG. 3 shows the monitor and panel of FIG. 2 after a spin providing symbols and payout notice on the screen.

FIG. 4 shows the monitor if FIG. 1 where wagers have been placed on 3 of the 8 available arcs.

FIG. 5 shows the monitor of FIG. 4 after a spin, with a winning outcome shown in arc 1 upon which a wager was made, but no win shown in arc 8 where a winning combination appeared, but no wager had been made.

FIG. 6 shows 24 panels of a video screen where from panel to panel, an additional symbol is inserted onto the screen inside of arcs in a specific sequence.

FIG. 7 shows a screen where all arc positions have been filled with symbols, and a central position in the circle of symbols is provided with an additional symbol that can be used in special play features of a video game.

FIG. 8 shows a bonus screen comprising orbiting symbols about a central symbol, the orbiting symbols and the central symbol being player selectable symbols that may mask value hidden beneath the symbols.

FIG. 9 shows the screen of FIG. 8 after two of the symbols have been selected and bonus values beneath the symbols have been exposed.

FIG. 10 shows the screen of FIG. 8 after four of the symbols have been selected and bonus values beneath the symbols have been exposed.

FIG. 11 shows the screen of FIG. 8 after six of the symbols have been selected and bonus values beneath four of the symbols have been exposed and a symbol that ends the bonus round has been displayed on the sixth pick.

### DETAILED DESCRIPTION OF THE INVENTION

The games and formats of games in the present invention may be practiced on conventional video gaming equipment with substantially only software, game rules, and player control button configurations being changed on the video gaming equipment. The basic equipment would ordinarily include at least a housing, a processor, a monitor, credit/currency/coin acceptors and controls, player controls, and software directing the game, game rules and video displays that are used for games of this invention.

The basic play of games according to the invention includes the provision of a circular or oval representation of symbols in various formats, the symbols being provided in a set of concentric (in the format of a circle) or confocal (in the format of an ellipse, about the two focal points) orbits. The symbols in the orbits can align when the symbols are stopped when spun, or when symbols are provided to the various available symbol positions available in the orbits. Paylines for the symbols may comprise radial alignments of symbols within an arc of the circle or oval (generally an ellipse), symbols oriented along the arc of the circle or ellipse, scatter pays, alignments of symbols within arcs that intersect at predetermined angles at the approximate center of the circle or ellipse (e.g., 180°, 80°, 120°, 45° or whatever orientation is selected as a payline), combinations of symbols with an additional symbol displayed in a position central to the circle or ellipse, or in another positioned designated for special symbols on the screen, and other special orientations of symbols that may be unique to circles and ellipses. It is particularly desirable for the symbols to be theme oriented as is typical with video slot machines, using such standard symbols, for example, as bars, cherries, oranges, SEVENS, bells, plums, lemons, and the like. Sets of theme related symbols such as horses, jockeys, saddles, harnesses, horse heads, jockey caps, starting gates, race tracks, wagering tickets, and the like may be used. Themed sets of symbols are distinguished from the use of symbols that define items of specific ranks where the ranks are combined into sets of predetermined ranks, such as poker playing cards, dice in a Yahtzee® dice game, and the like. It is also preferred that themed sets of symbols are used as opposed to rankable sets of symbols that are integral to the determination of a winning hand, and that order dependency is important (e.g., a cherry in the first slot pays, while a cherry in the second slot doesn't pay), that like quantities of symbols may differ in payout (e.g., three SEVENS pays out more than three single BARS, and more than three cherries. The use of video gaming equipment offers much greater flexibility in the visual aspects of play of the game. For example, if concentric sets of physical wheels were used, there would be a strong limitation on the number of symbols available, the size of the equipment would be severely limited by the radially increasing size of the wheels, all symbols on a single wheel would have to stop at the same time, and other physical limitations are imposed upon the design and play of such a system.

One perspective of the games according to the present invention can be described as follows. A method is performed for displaying paylines on a video gaming apparatus having a display surface (such as a CRT screen, plasma screen, LCD screen, LED screen or any other analog or digital display screen). Images of symbols are provided onto the screen (usually from a file of images) in at least one pattern. The pattern is usually selected from the group consisting of circle patterns, oval patterns, ellipse patterns or other patterns that approximate a distribution of the symbols around a generally central area or point (although, as with comets, individual symbol positions may pass close to the center area or point). The patterns are generally divided into radial or focal distributions of symbols (e.g., as with slices of pie, which may be equal in area or as with Keplerian astral distributions of area, uneven in size and dimensions). Paylines are formed by the patterns of symbols in the radial or focal distributions (e.g., the slices), the paylines being predetermined by selection by a player. By predetermined selection it is meant that, where there are X possible paylines, the player wagers on Y paylines, wherein Y≦X. For example, there may be a total of nine paylines numbered 1-9, and wagering on seven paylines will predetermine award determination on paylines 1-7. Alternatively, when the player wagers on Y (e.g., 4) paylines, the player may select the specific paylines (e.g., 3, 4, 7 and 8) one which the wagers will be distributed. As is typical in wagering devices, the paylines determine combinations of symbols that can identify an award. The paylines are usually ‘radial,’ that is, emanating from the central area or point outwardly (or inwardly towards the central area or point), and may comprise 3, 4, 5 or more symbols. Additionally, bonus events or special prizes or supplemental awards may be based upon the appearance of predetermined symbols or arrangement of symbols within a single orbit (that is, in one of the circular, oval or elliptical patterns of distribution. This type of award, and the combination of awards, could not be performed in mechanical concentric wheels, as the mechanical or physical wheels cannot rearrange the symbols in both the radial and orbital directions.

The symbols that are used to determine awards may be added to the patterns one-at-a-time or en masse. There may be at least two paylines which are available in the images of symbols in a pattern, that is, two radial paylines, and/or a radial pay line and an orbital payline. The method is preferably performed where there are at least four paylines which are available in the images of symbols in a pattern (e.g., a quarter-cut pie shape, or more pie cuts in the circular, oval or elliptical distribution of symbols). The circular, oval or elliptical distributions may have lines or other tracers or image patterns on the screen assisting in the definition of the location of the distribution and other tracers or lines assisting in the definition of the paylines. The images of the symbols that are used to determine awards may be exposed in a predetermined order on the display surface, but not necessarily in a single repeating pattern. For example, the system may provide nine paylines with five symbol positions in each payline (for 45 symbol positions). The processor may randomly select which symbol position from among the 45 will be first filled, then determine the second remaining symbol position, etc., until all symbol positions are filled. The system may operate in any jurisdictionally legal manner of randomly determining awards, such as by weighting the probability of individual symbols (e.g., U.S. Pat. No. 4,448,419), or by randomly providing complete or partial templates of final displays and then selecting symbols allowed or required in the template. The method may provide paylines comprise radial lines from a central area that include at least three symbols, and optionally additional paylines are provided along lines that form a circle or ellipse around the central area (e.g., an orbital distribution). An orbital distribution alone may be used, remembering that because the symbols are virtual symbols visually displayed, the system offers much greater flexibility than a mechanical system with fixed orientation and arrangement of symbols on an orbital wheel (as in U.S. patent application Ser. No. 2003/0027628). The symbols, as described above, may be added to the paylines randomly; at least one symbol is added to the paylines one-at-a-time without prior display of the at least one symbol as virtually moving (that is, symbols are displayed on the backgrouns without any previous virtual indication of movement, but merely emerges spontaneously onto the screen in a payline appropriate position); individual symbols may be displayed along paylines one-at-a-time with at least three consecutive displayed symbols being displayed in three non-adjacent symbol display positions (e.g., a first symbol may be displayed on the innermost orbit along one radial payline path, a second symbol may be displayed in the fourth orbital path in another radial payline path, and a third symbol is displayed in the third orbital path in a third radial payline path (or in the first payline path, since the three positions cannot be considered consecutive or adjacent). Each symbol may appear to have a unique orbit during a period of virtual movement of symbols, that is, rather then having each orbital row of finally displayed symbols define single orbits, at least some of the individual symbols may move in more independent and individual paths, such as more eccentric comet-like paths, finally settling for display into a payline display position. All symbols may appear to move in orbits about a central area or at least one set of symbols moves within a single orbit. An apparatus according to the invention may comprise a housing, a video screen and a processor. The processor would contain software or on-line connection to software enabling play of the method of the invention. Any conventional or uniquely designed processor, I/O, motherboards, sisterboards, hardware and software may be used, in any convenient computer language.

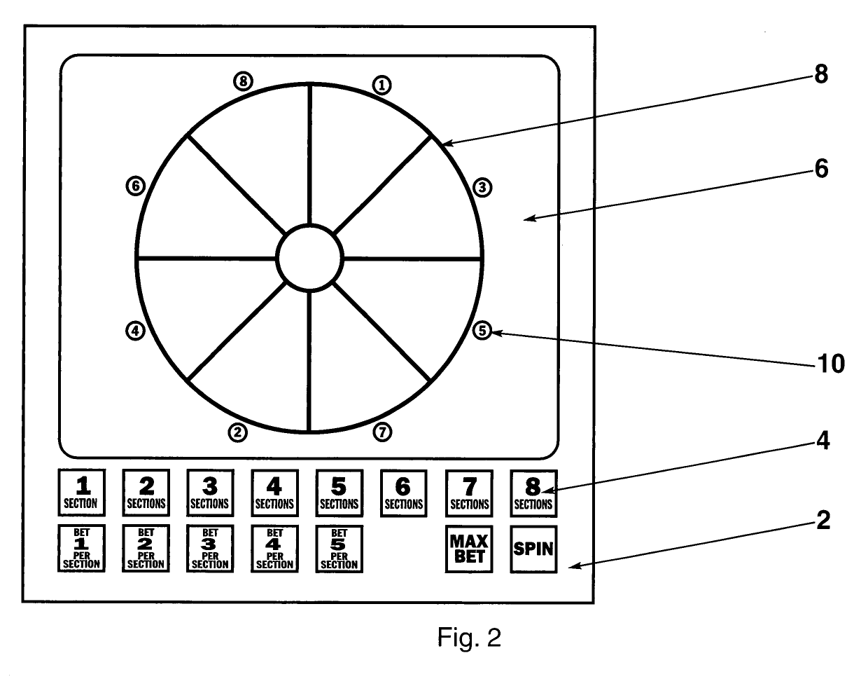

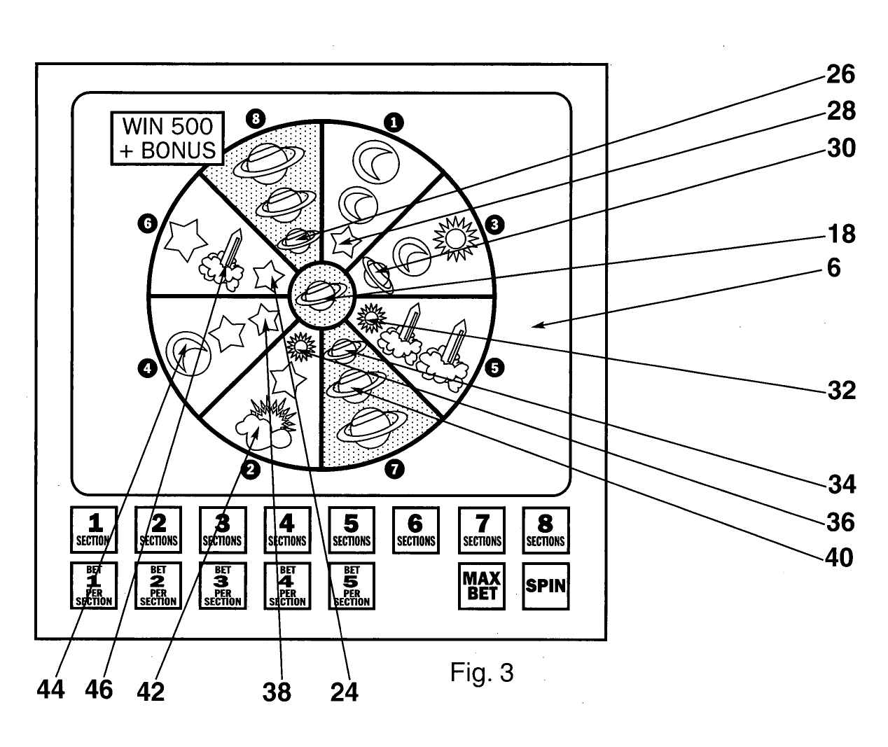

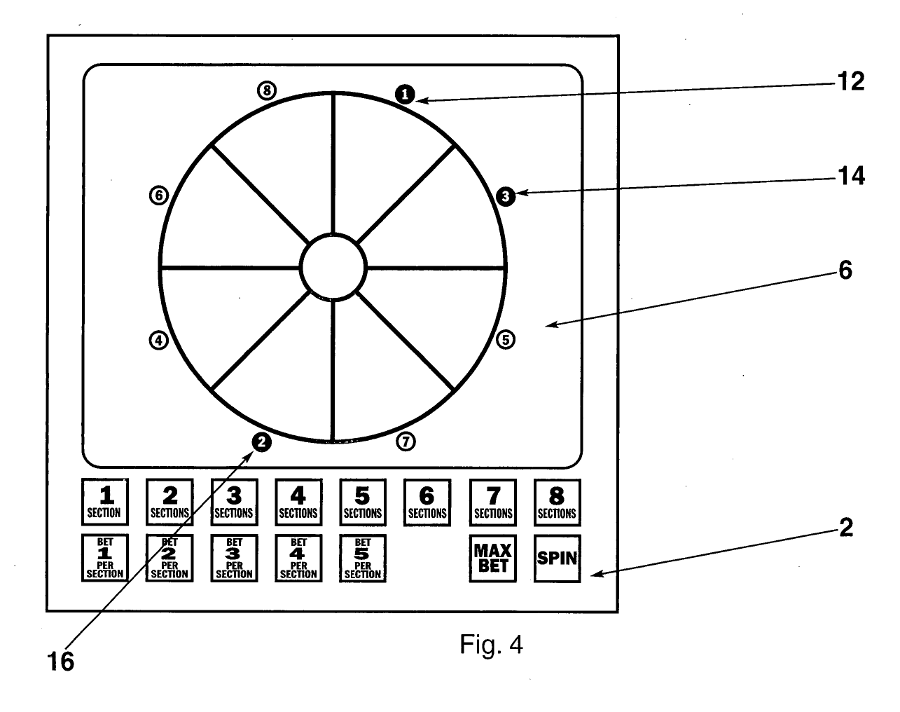

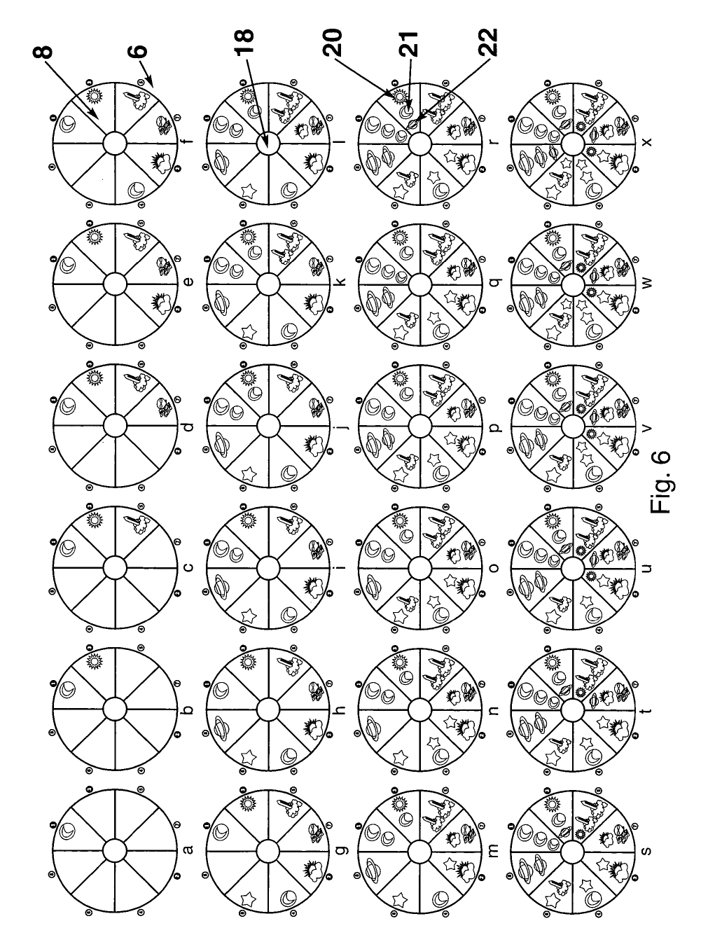

The symbols may be provided in various different ways to increase viewer enjoyment. A basic method is shown in FIGS. 2, 4 and 6. FIG. 2 shows a game apparatus 2 having player control buttons 4, a display screen 6, and a circular format 8 for display of symbols within the numbered 10 eight arcs of about 45° for each arc. FIG. 4 shows the apparatus 2 of FIG. 4 with wagers having been placed on arcs 1 (12), 3 (14) and 2 (16), so those numbers are highlighted on the screen 6. FIG. 6 shows a panel of 24 screens a-x with a sequence of symbol placements shown progressing alphabetically. Panel a shows the exposure of a first symbol in the outermost orbit position in arc 1. The selection of this particular starting position is predetermined and within the control of the designer. The first symbol exposure could have as easily been displayed on the innermost orbit in arc 8 or in the central frame 18. A preferred method is the display of the symbols one-at-a-time in the available symbol positions, the display of all symbols preferably occurring under 30 seconds, preferably under 15 seconds, and more preferably in under 10 seconds. In the embodiment shown in FIG. 6, in panel b two symbols have been disclosed, in panel c three symbols have been disclosed, progressing to panel x where twenty-four symbols have been disclosed. An additional symbol may be displayed in space 18. In this particular format, the symbols are displayed at least one-at-a-time in a clockwise manner, from the outer orbits inward. It is equally possible to display the symbols starting on an inner orbit and moving counterclockwise. Looking at panel r it can be seen that symbols may be displayed by a pattern moving from symbol 20 to symbol 21 and then to symbol 22. Subsequent symbols may be displayed in arcs in a pattern (e.g., clockwise or counterclockwise) or randomly displaying symbols within arcs or displaying all symbols within an arc in a pattern or randomly. Awards may be provided for symbol appearances within arcs, and special combinations of symbols in arcs wagered upon. For example, looking at FIG. 3, the appearance of the same symbols in arcs that have been wagered upon (here arcs 8 and 7) and/or arcs that have been wagered upon with the symbol in space 18 being present in an arc may determine wins or bonus event starts or awards. Paylines may be provided in additional positions that are not available in conventional rectangular symbol displays, such as all symbols within an orbit (e.g., if the same symbols were present in positions 24, 26, 28, 30, 32, 34, 36 and 38; or if the same symbols were present in at least three or at least five adjacent positions within an orbit such as 26, 28 and 30, or 28, 30, 32, 34 and 36). It is also possible to provide paylines on curved radii such as would be formed by 32, 40 and 42 or continued patterns such as 32, 40, 42, 44, 46 and 26.

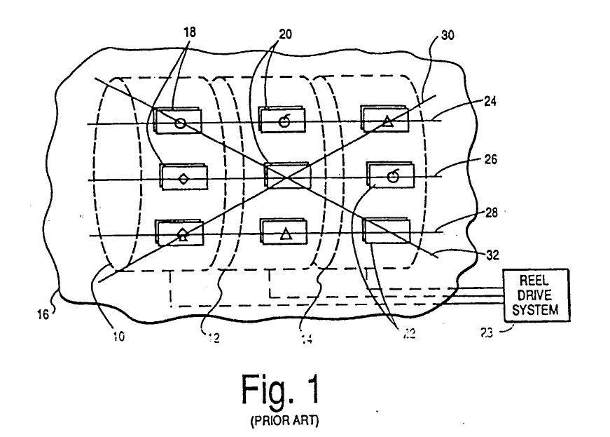

FIG. 1 shows a typical video gaming display of reel positions to determine payout lines.

FIG. 2 shows a video monitor and panel with player control buttons and eight wagering arcs of 45° segments 8 (arcs of 45° in a circle), each segment having a number 10 thereon. Player control buttons 4 can identify the activities under selection or control by the player.

FIG. 3 shows the monitor and panel of FIG. 2 after a spin providing symbols and payout notice on the screen.

FIG. 4 shows the monitor 6 of FIG. 1 where wagers have been placed on 3 of the 8 available arcs 8, numbered 12, 14 and 16.

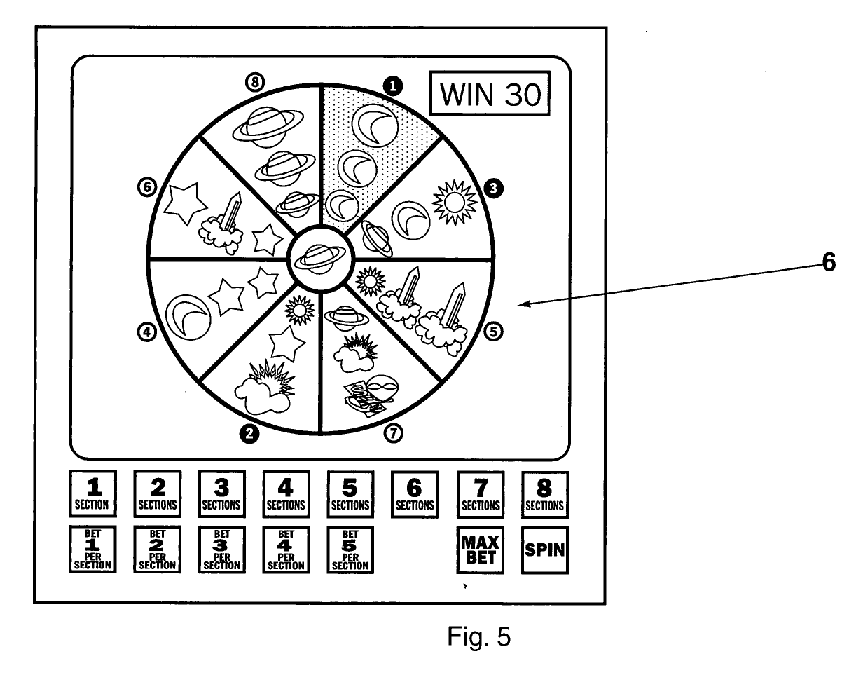

FIG. 5 shows the monitor 6 of FIG. 4 after a spin, with a winning outcome shown in arc 1 upon which a wager was made on arcs 1, 2 and 3, but no win shown in arc 8 where a winning combination appeared, but no wager had been made.

FIG. 6 shows 24 panels a-x of a video screen 6 where from panel to panel, an additional symbol is inserted onto the screen inside of arcs 8 in a specific sequence.

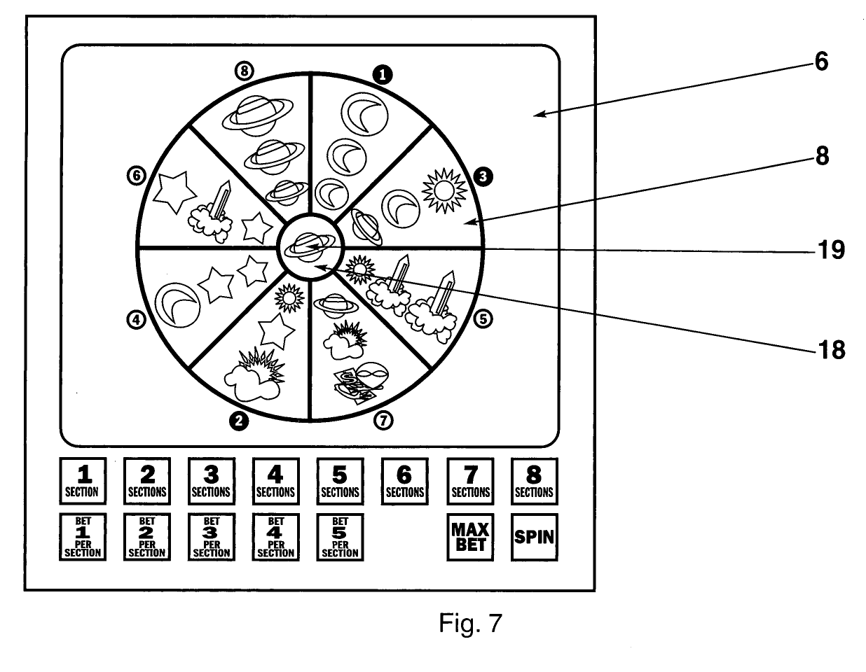

FIG. 7 shows a screen where all arc positions 8 have been filled with symbols, and a central position 18 in the circle of symbols is provided with an additional symbol 19 that can be used in special play features of a video game.

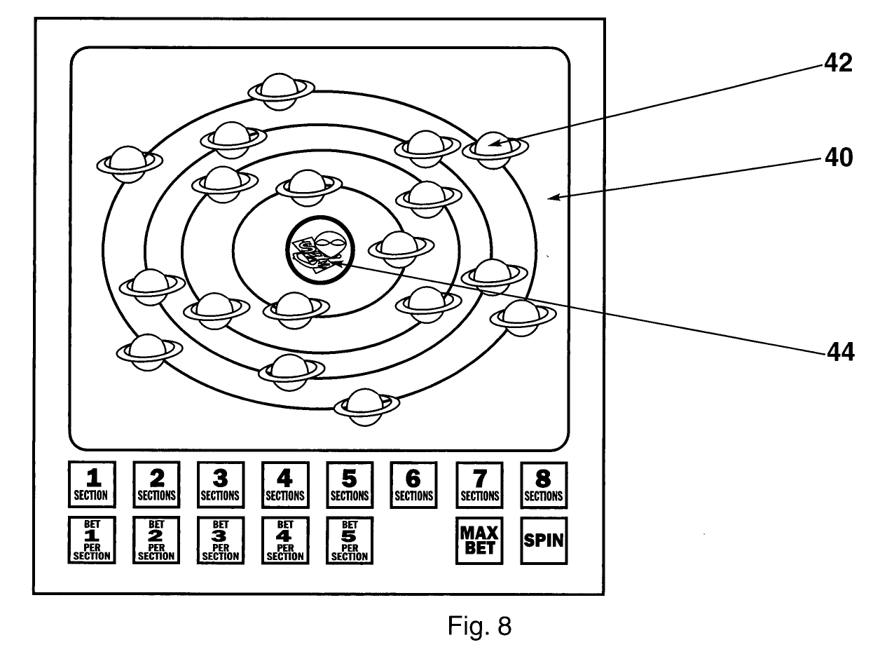

FIG. 8 shows a bonus screen 40 comprising orbiting symbols 42 about a central symbol 44, the orbiting symbols 42 and the central symbol 44 being player selectable symbols that may mask value hidden beneath the symbols.

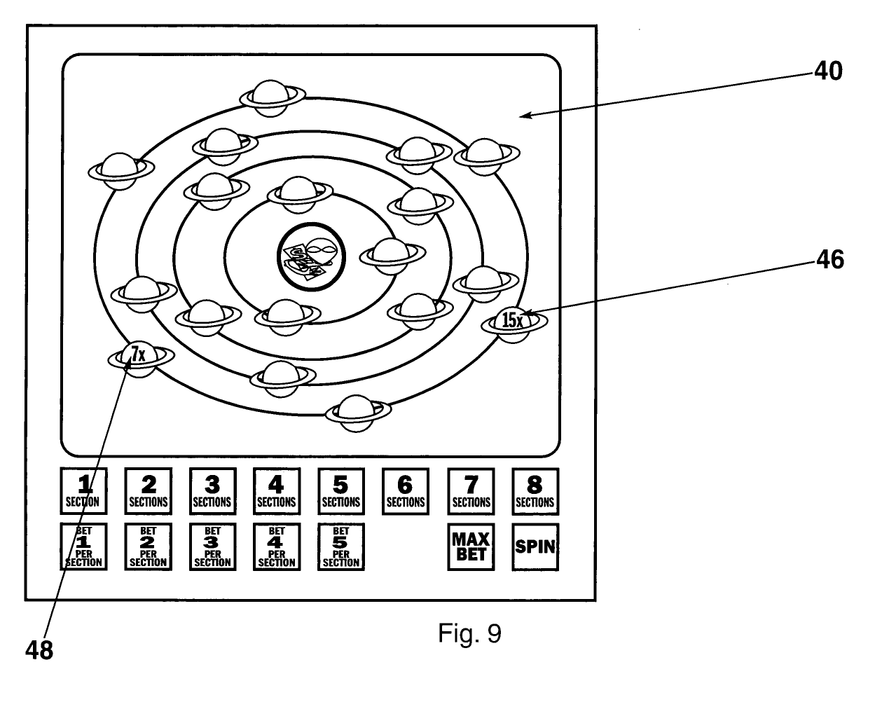

FIG. 9 shows the screen of FIG. 8 after two of the symbols 46 and 48 have been selected and bonus values beneath the symbols have been exposed.

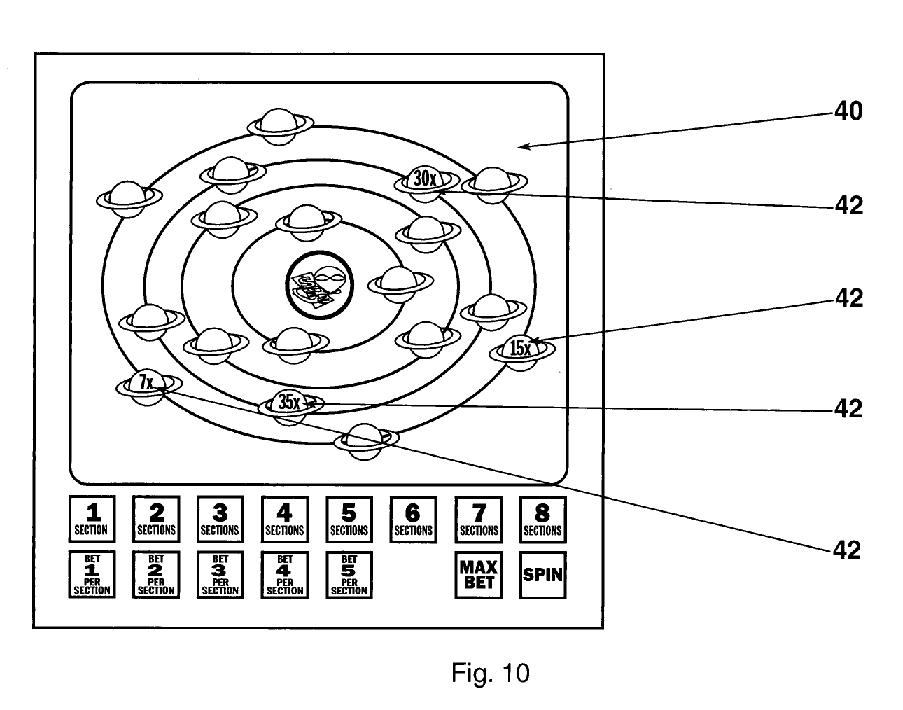

FIG. 10 shows the screen of FIG. 8 after four of the orbiting symbols 42 have been selected and bonus values beneath the symbols have been exposed.

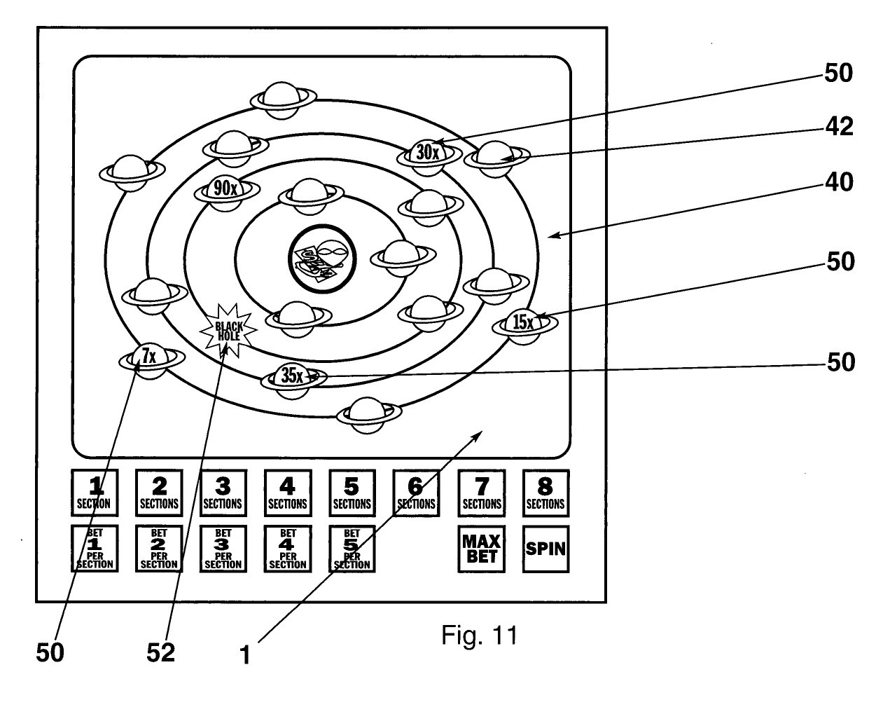

FIG. 11 shows the screen of FIG. 8 after five of the symbols have been selected and bonus values beneath five of the symbols 50 have been exposed and a symbol 52 that ends the bonus round has been displayed on the sixth pick.

It is to be understood that these descriptions are intended to be general, enabling and illustrative, and the specific features described are not intended to narrowly limit the scope of the invention which is described. Those skilled in the art will recognize the alternatives that can be used within the scope described.

What is claimed:

1. A method of displaying paylines on a video gaming apparatus having a display surface by providing images of symbols in at least one pattern selected from the group consisting of circle patterns or ellipse patterns, the patterns being divided into radial or focal distributions of symbols, paylines being formed by the patterns of symbols in the radial or focal distributions, the paylines being predetermined by selection by a player, and the paylines determining combinations of symbols that can identify an award.

2. The method of claim 1 wherein symbols that are used to determine awards are added to the patterns one-at-a-time.

3. The method of claim 1 wherein there are at least two paylines which are available in the images of symbols in a pattern.

4. The method of claim 1 wherein there are at least four paylines which are available in the images of symbols in a pattern.

5. The method of claim 1 wherein the images of the symbols that are used to determine awards are exposed in a predetermined order on the display surface.

6. The method of claim 1 wherein paylines comprise radial lines from a central area that include at least three symbols.

7. The method of claim 6 wherein additional paylines are provided along lines that form a circle or ellipse around the central area.

8. The method of claim 6 wherein paylines include at least two radial lines that are directed towards or away from the central area.

9. The method of claim 1 wherein symbols are added to the paylines randomly.

10. The method of claim 1 wherein at least one symbol is added to the paylines one-at-a-time without prior display of the at least one symbol as virtually moving.

11. The method of claim 1 wherein individual symbols are displayed along paylines one-at-a-time with at least three consecutive displayed symbols being displayed in three non-adjacent symbol display positions.

12. The method of claim 1 wherein each symbol appears to have a unique orbit during a period of virtual movement of symbols.

13. The method of claim 1 wherein all symbols appear to move in orbits about a central area.

14. The method of claim 13 wherein at least one set of symbols move within a single orbit.

15. An apparatus comprising a housing, a video screen and a processor, the processor containing software enabling play of the method of claim 1.

16. An apparatus comprising a housing, a video screen and a processor, the processor containing software enabling play of the method of claim 4.

17. An apparatus comprising a housing, a video screen and a processor, the processor containing software enabling play of the method of claim 7.

18. An apparatus comprising a housing, a video screen and a processor, the processor containing software enabling play of the method of claim 10.

19. An apparatus comprising a housing, a video screen and a processor, the processor containing software enabling play of the method of claim 12.

20. An apparatus comprising a housing, a video screen and a processor, the processor containing software enabling play of the method of claim 14.
